(19) United States
(12) Patent Application Publication
(10) Pub. No.: US 2009/0133714 A1
(43) Pub. Date: May 28, 2009

(54) METHOD FOR SURFACE TREATING SUBSTRATE AND PLASMA TREATMENT APPARATUS

(75) Inventors: Tadashi YAMAZAKI, Suwa (JP); Mitsuru KASAI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/270,125

(22) Filed: Nov. 13, 2008

(30) Foreign Application Priority Data
Nov. 22, 2007 (JP) 2007-302640

(51) Int. Cl. B08B 6/00

(52) U.S. Cl. 134/1.1; 134/198

(57) ABSTRACT

A method for surface treating a substrate includes supplying first plasma generated by using nitrogen gas and oxygen gas toward a substrate surface to surface treat the substrate surface in air. In the method, a volume ratio of the oxygen gas to a total supply of the nitrogen gas and the oxygen gas is smaller than a volume ratio of oxygen contained in air.

The entire disclosure of Japanese Patent Application No. 2007-302640, filed Nov. 22, 2007 is expressly incorporated by reference herein.

### BACKGROUND

1. Technical Field

The present invention relates to a method for surface treating a substrate and a plasma treatment apparatus, the method including a surface treatment step to remove organic substances from a substrate surface and reforming the substrate surface.

2. Related Art

As a method for cleaning a liquid crystal glass substrate used for a display, a method for surface treating a substrate has been disclosed in JP-A-2002-143795 (in FIG. 4 of page 4), for example. In the method for surface treating a substrate, plasma of gas preferably containing 20% to 30% by volume of oxygen gas is supplied to a substrate surface from a plasma nozzle of a plasma gun under an approximately atmospheric pressure. Oxygen radicals in plasma change organic substances adsorbed or formed on the substrate surface to low-molecular ones and oxidize them to be vaporized and removed from the substrate surface.

The related art method for surface treating a substrate, however, contains at most only 70% to 80% by volume of nitrogen gas since the gas that generates plasma preferably contains 20% to 30% volume of oxygen gas. The plasma includes excited nitrogen radicals and oxygen radicals. Some kinds of the nitrogen radicals have a long lifetime of several dozen seconds. In contrast, the oxygen radicals have a short lifetime of one second or less. In order to remove organic substances from the substrate surface, there must be a sufficient amount of oxygen radicals around the substrate. Additionally, in order to generate a necessary amount of oxygen radicals, there must be nitrogen radicals of a necessary amount to generate the oxygen radicals around the substrate. Nitrogen radicals generated from nitrogen gas of 70% to 80% by volume, however, may not generate a necessary amount of oxygen radicals around the substrate. As a result, organic substances are not efficiently removed from the substrate surface.

### SUMMARY

An advantage of the present invention is to provide a method for surface treating a substrate and a plasma treatment apparatus that efficiently remove organic substances from a substrate surface and reform the substrate surface.

According to a first aspect of the invention, a method for surface treating a substrate includes a surface treatment step in which first plasma generated by using nitrogen gas and oxygen gas is supplied toward a substrate surface to surface treat the substrate surface in air. In the step, a volume ratio of the oxygen gas to a total supply of the nitrogen gas and the oxygen gas is smaller than a volume ratio of oxygen in air.

The method includes a surface treatment step in which the first plasma generated by using nitrogen gas and oxygen gas is supplied toward the substrate surface to surface treat the substrate surface in air. In the step, the volume ratio of the oxygen gas to the total supply of the nitrogen gas and the oxygen gas is smaller than the volume ratio of oxygen in air. The first plasma includes excited nitrogen radicals and oxygen radicals. The nitrogen radicals have a longer lifetime of several dozen seconds than that of the oxygen radicals. In contrast, the oxygen radicals have a short lifetime of one second or less. The nitrogen radicals having a long lifetime collide, with a radical state, with nitrogen gas in a steady state or atoms and molecules of oxygen gas not only inside the plasma gun in which nitrogen radicals are generated and around the plasma gun but also around the substrate spaced apart from the plasma gun to generate fresh nitrogen radicals and oxygen radicals, returning to nitrogen of a steady state. On the other hand, the oxygen radicals having a short lifetime collide with the nitrogen gas in the steady state or atoms and molecules of oxygen gas inside the plasma gun in which oxygen radicals are generated and around the plasma gun to produce fresh nitrogen radicals and oxygen radicals, returning to oxygen of a steady state. As a result of the repeated collisions, the presence of nitrogen radicals and oxygen radicals can be continuously maintained. The oxygen radicals change organic substances adsorbed or formed on the substrate surface to low-molecular ones and oxidize them to be vaporized and removed from the substrate surface. When the substrate is made of an organic material, the oxygen radicals oxidize the substrate surface to generate a hydroxyl group. As a result, the substrate surface is reformed.

When the volume ratio of oxygen gas to the total supply of nitrogen gas and oxygen gas is too high, lowering the amount of nitrogen gas. As a result, nitrogen radicals necessary to generate oxygen radicals are insufficient. That is, nitrogen gas is required at a volume ratio of a constant one or more. In contrast, when the volume ratio of oxygen gas to the total supply of nitrogen gas and oxygen gas is too low, resulting in insufficient oxygen radicals being generated. That is, oxygen gas is required at a volume ratio of a constant one or more. Therefore, nitrogen gas and oxygen gas each have an adequate range of each volume ratio to the total supply of the nitrogen gas and the oxygen gas. The adequate volume ratio of each gas is as follows: the adequate volume ratio of oxygen gas to the total supply is smaller than the volume ratio of oxygen in air; and the adequate volume ratio of nitrogen gas to the total supply is larger than the volume ratio of nitrogen in air. Nitrogen radicals are generated by nitrogen gas having a higher volume ratio than the volume ratio of nitrogen in air. The generated nitrogen radicals can generate a necessary amount of oxygen radicals around the substrate. The necessary amount of oxygen radicals generated around the substrate can efficiently remove organic substances from and reform the substrate surface.

According to a second aspect of the invention, a method for surface treating a substrate includes a surface treatment step in which oxygen gas and second plasma generated by using nitrogen gas is supplied toward a substrate surface to surface treat the substrate surface in air. In the step, a volume ratio of the oxygen gas to a total supply of the nitrogen gas and the oxygen gas is smaller than a volume ratio of oxygen in air.

The method includes a surface treatment step in which oxygen gas and the second plasma generated by using nitrogen gas are supplied toward the substrate surface to surface treat the substrate surface in air. In the step, the volume ratio of the oxygen gas to the total supply of the nitrogen gas and the oxygen gas is smaller than the volume ratio of oxygen in air. The second plasma includes excited nitrogen radicals. The nitrogen radicals have a long lifetime of several dozen seconds. The nitrogen radicals collide with atoms and molecules of oxygen gas to generate excited oxygen radicals. The oxygen radicals have short lifetime of one second or less. The nitrogen radicals having a long lifetime collide, with a radical state, with nitrogen gas in a steady state or atoms and molecules of oxygen gas not only inside the plasma gun in which nitrogen radicals are generated and around the plasma gun but also around the substrate spaced apart from the plasma gun to generate fresh nitrogen radicals and oxygen radicals, returning to nitrogen of a steady state. On the other hand, the oxygen radicals having a short lifetime collide with the nitrogen gas in the steady state around the oxygen radicals or atoms and molecules of oxygen gas to generate fresh nitrogen radicals and oxygen radicals, returning to oxygen of a steady state. As a result of the repeated collisions, the presence of nitrogen radicals and oxygen radicals can be continuously maintained. The oxygen radicals change organic substances adsorbed or formed on the substrate surface to low-molecular ones and oxidize them to be vaporized and removed from the substrate surface. When the substrate is made of an organic material, the oxygen radicals oxidize the substrate surface to generate a hydroxyl group. As a result, the substrate surface is reformed.

When the volume ratio of oxygen gas to the total supply of nitrogen gas and oxygen gas is too high, lowering the amount of nitrogen gas. As a result, nitrogen radicals necessary to generate oxygen radicals are insufficient. That is, nitrogen gas is required at a volume ratio of a constant one or more. In contrast, when the volume ratio of oxygen gas to the total supply of nitrogen gas and oxygen gas is too low, resulting in insufficient oxygen radicals being generated. That is, oxygen gas is required at a volume ratio of a constant one or more. Therefore, nitrogen gas and oxygen gas each have an adequate range of each volume ratio to the total supply of the nitrogen gas and the oxygen gas. The adequate volume ratio of each gas is as follows: the adequate volume ratio of oxygen gas to the total supply is smaller than the volume ratio of oxygen in air; and the adequate volume ratio of nitrogen gas to the total supply is larger than the volume ratio of nitrogen in air. Nitrogen radicals are generated by nitrogen gas having a higher volume ratio than the volume ratio of nitrogen in air. The generated nitrogen radicals can generate a necessary amount of oxygen radicals around the substrate. The necessary amount of oxygen radicals generated around the substrate can efficiently remove organic substances from and reform the substrate surface.

In the method for surface treating a substrate, it is preferable that as a distance between the substrate surface and a plasma gun supplying the first plasma or the second plasma increase the volume ratio of the oxygen gas to the total supply decrease.

According to the method, as the distance between the plasma gun supplying the first plasma or the second plasma increases the volume ratio of the oxygen gas to the total supply is lowered. The longer the distance between the plasma gun and the substrate surface, the larger the volume of oxygen, in air around the first plasma, caught into the first plasma, and the smaller the volume ratio of nitrogen gas included in the first plasma around the substrate. Thus, the volume ratio between nitrogen gas and oxygen gas that are included in the first plasma around the substrate can be in an adequate range by reducing the volume ratio of oxygen gas included in the supplied first plasma as the distance increases. The longer the distance between the plasma gun and the substrate surface, the larger the volume of oxygen, in air around the second plasma and the oxygen gas, caught into the second plasma and the oxygen gas, and the smaller the volume ratio of nitrogen gas included in the second plasma and the oxygen gas around the substrate. Thus, the volume ratio between nitrogen gas and oxygen gas that are included in the second plasma and oxygen gas around the substrate can be in an adequate range by reducing the volume ratio of oxygen gas included in the supplied second plasma and oxygen gas as the distance increases. As a result, organic substances can be efficiently removed from the substrate surface and the substrate surface can be reformed even though the distance between the substrate surface and the plasma gun supplying the first plasma or the second plasma increases.

In the method, it is preferable that the volume ratio of the oxygen gas to the total supply be within a range of from 0.01 volume percent to 1 volume percent.

In the method, the volume ratio of oxygen gas supply to the total supply is within a range of from 0.01% to 1% by volume. This volume ratio range can keep oxygen radicals of minimum volume necessary to remove organic substances from and reform the substrate surface as well as nitrogen radicals enough for efficiently generating oxygen radicals. As a result, organic substances can efficiently removed from the substrate surface and the substrate surface can be reformed.

According to a third aspect of the invention, a plasma treating apparatus includes: a plasma gun that includes a container having a hollow shape, a pair of electrodes provided to an outer circumferential surface of the container so as to be opposed each other, and a plasma nozzle provided at one end of the container; a power supply applying a voltage between the pair of electrodes; a gas supply unit supplying gas to the container for generating plasma; and a flanged plate circularly bonded to the plasma nozzle.

The apparatus includes the flanged plate circularly bonded to the plasma nozzle. The flanged plate circularly bonded to the plasma nozzle keeps a constant distance from the substrate surface when the plasma nozzle is placed so as to face the substrate surface to be surface treated. This distance allows plasma supplied from the plasma nozzle to easily reach a wide area of the substrate surface. Additionally, it is difficult for the plasma supplied from the plasma nozzle to catch and include oxygen in air around the plasma. As a result, organic substances can efficiently removed overall from the substrate surface and reform the substrate surface.

In the apparatus, it is preferable that the flanged plate have a plasma nozzle side and an outer circumferential side, and be slanted such that the plasma nozzle side is closer to the plasma nozzle than the outer circumferential side in a direction along which the plasma is supplied.

The flanged plate is slanted from the plasma nozzle side to the outer circumferential side in the plasma supply direction. When the plasma nozzle is placed so as to face the substrate surface to be surface treated, the distance between the plasma nozzle side of the flanged plate and the substrate facing the plasma nozzle side is larger than the distance between the outer circumferential side of the flanged plate and substrate facing the outer circumferential side. This relation allows the plasma supplied from the plasma nozzle to easily be held between the flanged plate and the substrate surface. As a result, organic substances can more efficiently removed from the substrate surface and the substrate surface can be reformed.

### BRIEF DESCRIPTION OF THE DRAWINGS

The invention will be described with reference to the accompanying drawings, wherein like numbers reference like elements.

FIG. 1 is a schematic view illustrating a plasma treatment apparatus and a method for surface treating a substrate according to a first embodiment of the invention.

FIG. 2 is a graph illustrating a relationship between surface treatment conditions and contact angles.

FIG. 3 is an explanatory diagram of a contact angle measurement.

FIG. 4 is a schematic view illustrating a plasma treatment apparatus and a method for surface treating a substrate according to a second embodiment of the invention.

FIG. 5 is a schematic view illustrating a plasma treatment apparatus and a method for surface treating a substrate according to a third embodiment of the invention.

FIG. 6 is a schematic view illustrating a plasma treatment apparatus and a method for surface treating a substrate according to a modification of the invention.

### DESCRIPTION OF EXEMPLARY EMBODIMENTS

Embodiments of the invention are described with reference to the accompanying drawings. Note that drawings referred to in the following description are schematic views where the scales in the length and the breadth of members and parts differ from actual ones for ease of illustration.

### First Embodiment

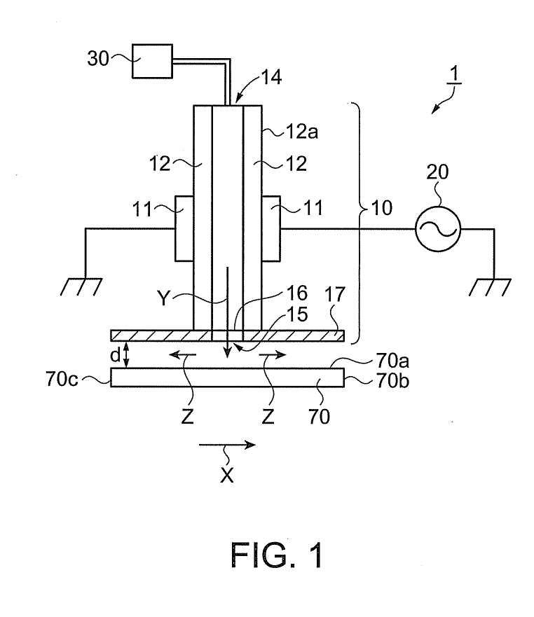

FIG. 1 is a schematic view illustrating a plasma treatment apparatus and a method for surface treating a substrate according to a first embodiment of the invention. As shown in FIG. 1, a plasma treatment apparatus 1 is provided such that a plasma nozzle 15 thereof faces a substrate 70 to be surface treated.

The substrate 70 is made of borosilicate glass and capable of moving in a direction of an arrow X. The plasma treatment apparatus 1 includes a plasma gun 10, a power supply 20, and a gas supply unit 30. The plasma gun 10 includes a container 12 having a hollow shape, a pair of electrodes 11, a gas-introducing inlet 14, a plasma nozzle 15, a foreign particle trap 16, and a flanged plate 17. The pair of electrodes 11 is disposed to an outer circumferential surface 12a of the container 12 so as to be opposed each other. The plasma nozzle 15 is provided at one end of the container 12. The gas-introducing inlet 14 is provided at the other end, opposite to the one end, of the container 12. The foreign particle trap 16 is formed with a perforated plate and functions to trap foreign particles produced by plasma. The flanged plate 17 is circularly bonded to the plasma nozzle 15. The power supply 20 functions to apply voltage between the pair of electrodes 11. The gas supply unit 30 functions to supply gas to the container 12 to generate plasma. The flanged plate 17 is made of stainless steel. The flanged plate 17 faces a substrate surface 70a with a constant distance d (the plasma nozzle 15 also keeps a constant distance with the substrate surface 70a).

Next, a method for surface treating the substrate 70 is described. As shown in FIG. 1, the substrate 70 is placed such that the substrate surface 70a faces the plasma nozzle 15 and the flanged plate 17. The power supply 20 is operated. The gas supply unit 30 feeds nitrogen gas and oxygen gas at a regulated flow rate. The fed nitrogen and oxygen gases are introduced inside the container 12 from the gas-introducing inlet 14 to reach a portion inside the container 12 between the pair of electrodes 11.

With the power supply 20 in operation, a high frequency voltage is applied between the pair of electrodes 11, generating first plasma (not shown) at the portion inside the container 12 between the pair of electrodes 11 The first plasma includes excited nitrogen radicals and oxygen radicals. The nitrogen radicals have a longer lifetime of several dozen seconds than that of the oxygen radicals. In contrast, the oxygen radicals have a short lifetime of one second or less. The first plasma moves in a plasma supply direction Y indicted with the arrow and is supplied to the substrate 70 as remote plasma from the plasma nozzle 15. During this supply, the substrate 70 moves in a direction of the arrow X at a constant moving speed. The first plasma supplied as described above moves from the plasma nozzle 15 and the substrate surface 70a that the plasma nozzle 15 faces to their peripheries (to a direction of an arrow Z), i.e., diffuses between the substrate surface 70a and the flanged plate 17.

The nitrogen radicals having a long lifetime collide with a radical state with nitrogen gas in a steady state or atoms and molecules of oxygen gas not only inside the plasma gun 10 in which nitrogen radicals are generated and around the plasma gun 10 but also around the substrate 70 spaced apart from the plasma gun 10 to generate fresh nitrogen radicals and oxygen radicals, returning to nitrogen of a steady state. On the other hand, the oxygen radicals having a short lifetime collide with the nitrogen gas in the steady state or atoms and molecules of oxygen gas inside the plasma gun 10 in which oxygen radicals are generated and around the plasma gun 10 to produce fresh nitrogen radicals and oxygen radicals, returning to oxygen of a steady state. As a result of the repeated collisions, the presence of nitrogen radicals and oxygen radicals can be continuously maintained.

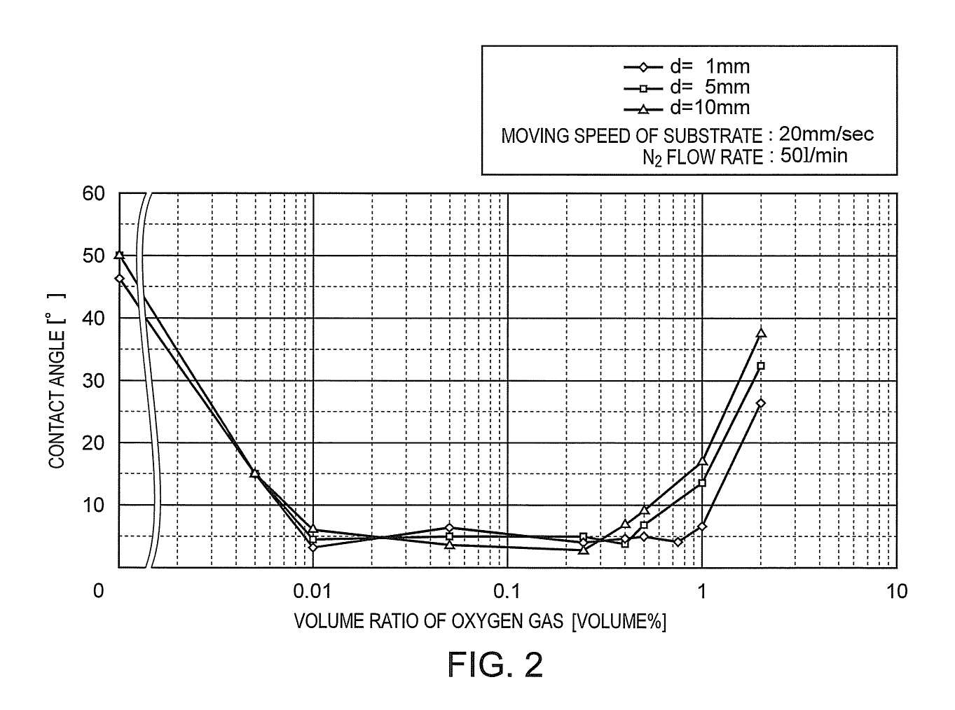

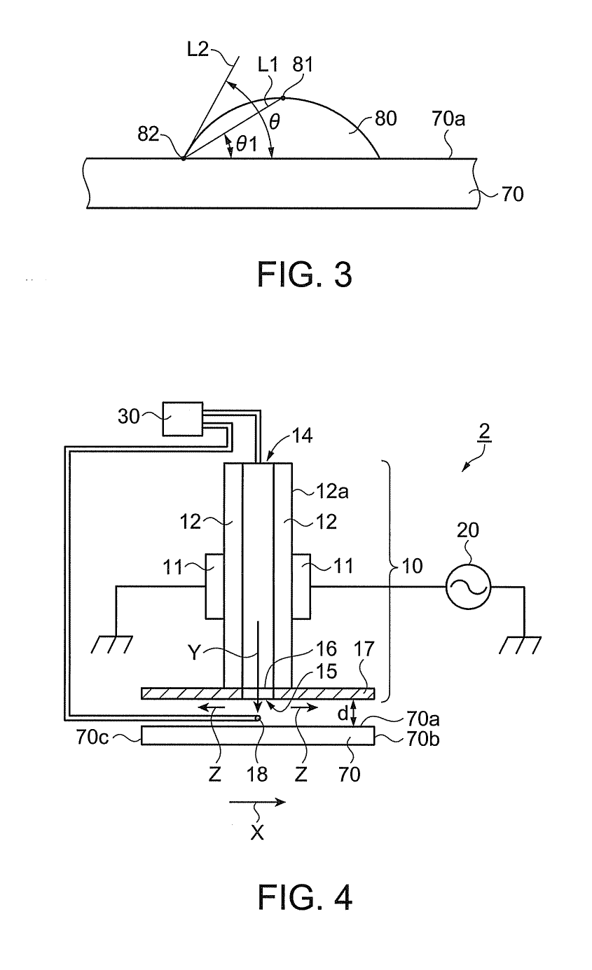

Next, surface treatment conditions on a substrate and measurement results of a contact angle θ are described. The contact angle θ is measured before and after a surface treatment to confirm the effect of the surface treatment. FIG. 2 is a graph illustrating a relationship between surface treatment conditions and contact angles. FIG. 3 is an explanatory diagram of a contact angle measurement. As shown in FIG. 2, the surface treatment conditions are set as follows: the flow rate of nitrogen gas supplied from the gas supply unit 30 is fixed at 50 l/minute; and the flow rate of oxygen gas is set according to a volume ratio of oxygen gas flow volume to a total supply volume of nitrogen gas and oxygen gas. The volume ratio is shown in the abscissa axis. One of the conditions is as follows: oxygen gas flow rate is 5 cc/minute when the volume ratio of oxygen gas is 0.01% by volume. The applied voltage from the power supply 20 is fixed at 1 KW. The power supply frequency is 100 KHz. The distance d is set in three conditions: 1 mm, 5 mm, and 10 mm. The moving speed of the substrate 70 is 20 mm/second. Contact angles are measured using a contact angle meter (Drop Master 700; manufactured by Kyowa Interface Science Co., Ltd.) with pure water as a reagent solution in a manner of a half-theta (θ) method. In the half-theta method, as shown in FIG. 3, a droplet 80 of pure water with a constant amount is dropped on the substrate surface 70a. Within a predetermined time period after being dropped, an angle θ1 is measured. The angle θ1 is made by the substrate surface 70a and a line L1 connecting a top 81 and an end 82 of the droplet 80. Here, the half-theta method is based on a precondition that the profile of the droplet 80 is a part of a sphere. Therefore, θ is equal to 2θ1 where θ is a contact angle made by the substrate surface 70a and a contact line L2 passing through the end 82 of the droplet 80. In this case, the substrate 70 was left for about 3 months in a room after being cleaned before the surface treatment, so that organic substances were adsorbed. The measurement result of the contacting angle θ was about 65 degrees.

As shown in FIG. 2, the contacting angle of the substrate 70 after the surface treatment is 10 degrees or below in the cases of the distance d is 1 mm, 5 mm, and 10 mm where the volume ratio of oxygen gas is within a range of from 0.01% to 0.5% by volume. This result shows an excellent effect achieved by removing organic substances from the substrate surface 70a. In the case of the distance d is 1 mm, the contacting angle of the substrate 70 after the surface treatment is around 5 degrees where the volume ratio of oxygen gas is within a range of from 0.01% to 1% by volume. This result shows an exceptional effect achieved by removing organic substances from the substrate surface 70a. As the distance d increases to 1 mm, 5 mm, and 10 mm, lowering the volume ratio of oxygen gas in a higher rate range allows organic substances to be effectively removed from the substrate surface 70a.

An example of the conditions of surface treating the substrate 70 is as follows: the distance d is 1 mm; and the volume ratio of supplied oxygen gas is within a range of from 0.01% to 0.05% by volume. The generated oxygen radicals change organic substances adsorbed or formed on the substrate surface 70a to low-molecular ones and oxidize them to be vaporized and removed from the substrate surface 70a. The organic substances were able to be sequentially removed from one end 70b to the other end 70c opposite to the one end 70b of the substrate surface 70a by moving the substrate 70 in the direction of the arrow X at a constant moving speed as described above as shown in FIG. 1.

The first embodiment provides the following effects.

(1) Nitrogen radicals are generated by nitrogen gas having a higher volume ratio than the volume ratio of nitrogen contained in air. The generated nitrogen radicals can generate a necessary amount of oxygen radicals around the substrate 70. The necessary amount of oxygen radicals generated around the substrate 70 can efficiently remove organic substances from the substrate 70.

(2) The longer the distance d between the plasma nozzle 15 and the substrate surface 70a, the larger the volume of oxygen, in air around the applied first plasma, caught into the first plasma, and the smaller the volume ratio of nitrogen gas included in the first plasma around the substrate 70. Thus, the volume ratio between nitrogen gas and oxygen gas that are included in the first plasma around the substrate 70 can be in an adequate range by reducing the volume ratio of oxygen gas included in the first plasma supplied as the distance d increases. As a result, organic substances can be efficiently removed from the substrate surface 70a even though the distance becomes longer between the substrate surface 70a and the plasma nozzle 15 supplying the first plasma.

(3) The volume ratio of oxygen gas supply to the total supply is from 0.01% to 0.5% by volume. This volume ratio range can keep oxygen radicals of minimum volume necessary to remove organic substances from and reform the substrate surface 70a as well as nitrogen radicals enough for efficiently generating oxygen radicals. As a result, organic substances can be efficiently removed from the substrate surface 70a.

(4) The plasma treatment apparatus 1 is provided with the flanged plate 17 circularly bonded to the plasma nozzle 15. The flanged plate 17 circularly bonded to the plasma nozzle 15 keeps a constant distance from the substrate surface 70a when the plasma nozzle 15 is placed so as to face the substrate surface 70a to be surface treated. This distance allows plasma supplied from the plasma nozzle 15 to easily reach a wide area of the substrate surface 70a. Additionally, it is difficult for the plasma supplied from the plasma nozzle 15 to catch and include oxygen in air around the plasma. As a result, organic substances can be efficiently removed overall from the substrate surface 70a.

### Second Embodiment

In a second embodiment of the invention, only the differences from the first embodiment are described. FIG. 4 is a schematic view illustrating a plasma treatment apparatus and a method for surface treating a substrate according to the second embodiment. As shown in FIG. 4, a plasma treatment apparatus 2 is provided with the gas supply unit 30 having two lines. One line feeds nitrogen gas at a regulated flow rate while the other line feeds oxygen gas at a regulated flow rate. The fed nitrogen gas is introduced inside the container 12 from the gas-introducing inlet 14 to reach a portion inside the container 12 between the pair of electrodes 11. With the power supply 20 in operation, a high frequency voltage is applied between the pair of electrodes 11, generating second plasma (not shown) at the portion inside the container 12 between the pair of electrodes 11. The second plasma includes excited nitrogen radicals. The second plasma moves in the plasma supply direction Y indicted with the arrow and is supplied to the substrate 70 as remote plasma from the plasma nozzle 15. On the other hand, the fed oxygen gas is supplied to the substrate surface 70a from an oxygen gas nozzle 18 provided in the vicinity of the substrate surface 70a. The supplied oxygen gas is mixed with the second plasma. In the mixed state, the nitrogen radicals collide with the oxygen gas to generate oxygen radicals.

The second embodiment provides the following effects.

(5) The longer the distance d between the plasma nozzle 15 and the substrate surface 70a facing the plasma nozzle 15, the larger the volume of oxygen, in air around the supplied second plasma and oxygen gas, caught into the second plasma and oxygen gas, and the smaller the volume ratio of nitrogen gas included in the second plasma and oxygen gas around the substrate 70. Thus, the volume ratio between nitrogen gas and oxygen gas that are included in the second plasma and oxygen gas around the substrate 70 can be in an adequate range by reducing the volume ratio of oxygen gas included in the supplied second plasma and oxygen gas as the distance d increases. As a result, organic substances can be efficiently removed from the substrate surface 70a even though the distance becomes longer between the plasma nozzle 15 and the substrate surface 70a facing the plasma nozzle 15.

### Third Embodiment

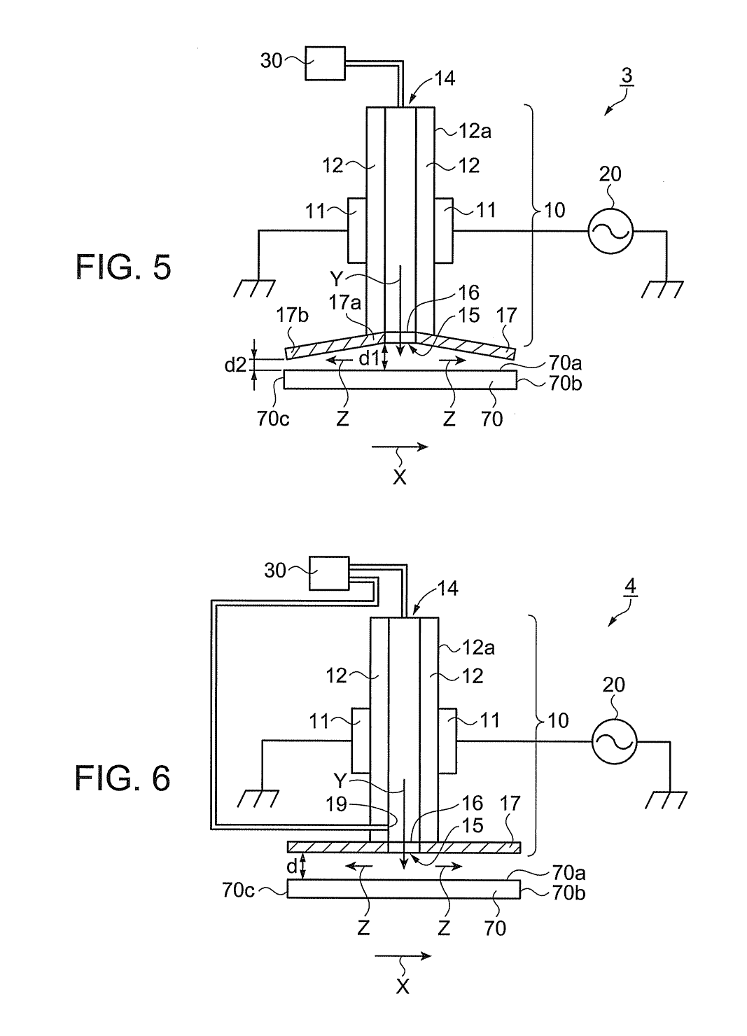

In a third embodiment, only the differences from the above-described embodiments are described. FIG. 5 is a schematic view illustrating a plasma treatment apparatus and a method for surface treating a substrate according to the third embodiment. As shown in FIG. 5, a plasma treatment apparatus 3 is provided with the flanged plate 17 having a slanted shape from a plasma nozzle side 17a to an outer circumferential side 17b. That is, the flanged plate 17 is slanted such that the plasma nozzle side 17a is closer to the plasma nozzle 15 than the outer circumferential side 17b in the plasma supply direction shown with the arrow. Here, an inner circumferential side distance d1 is defined as a distance between the plasma nozzle side 17a and the substrate 70 while an outer circumferential side distance d2 is defined as a distance between the outer circumferential side 17b and the substrate 70. The distances d1 and d2 satisfy a relation of d1>d2.

The third embodiment provides the following effects.

(6) The flanged plate 17 is slanted from the plasma nozzle side 17a to the outer circumferential side 17b in the plasma supply direction Y indicated with the arrow. This structure allows the distances d1 and d2 to satisfy a relation of d1>d2 when the plasma nozzle 15 is placed so as to face the substrate surface 70a to be surface treated. Here, the inner circumferential side distance d1 is a distance between the plasma nozzle side 17a and the substrate 70 while the outer circumferential side distance d2 is a distance between the outer circumferential side 17b and the substrate 70. This relation allows the first plasma supplied from the plasma nozzle 15 to easily be held between the flanged plate 17 and the substrate surface 70a. As a result, organic substances can be more efficiently removed from the substrate surface 70a.

It should be understood that the above-described embodiments are not limited to the contents described above but various kinds of modifications can be done other than the contents without departing from the spirit. A modification of the embodiments is described.

FIG. 6 is a schematic view illustrating a plasma treatment apparatus and a method for surface treating a substrate according to an example of the modification. As shown in FIG. 6, a plasma treatment apparatus 4 is provided with the gas supply unit 30, which may have two lines so as to be connected to the container 12. One line feeds nitrogen gas at a regulated flow rate and the other line feeds oxygen gas at a regulated flow rate. The fed oxygen gas is introduced inside the container 12 from an oxygen gas inlet 19 to be mixed with the second plasma inside the container 12. In the mixed state, nitrogen radicals in the second plasma collide with oxygen gas to produce oxygen radicals.

The plasma treatment apparatus 2 may be provided with the flanged plate 17 shown in FIG. 5.

The distance d may be more than 1 mm and 10 mm or less.

Examples of the substrate 70 may include an inorganic substrate made of such as white sheet glass, quartz, quartz crystal, and alumina; an organic substrate made of such as acrylic resins, polycarbonate resins, polyimide resins, epoxy resins, and urethane resins; and a metallic substrate made of such as iron, copper, titanium, aluminum, and their respective alloys. Composite substrates of the inorganic substrate, the organic substrate, and the metallic substrate may also be used.

Examples of the organic substances to be removed from the substrate 70 may include: processing solutions such as stamping oils and cutting oils; and surface treatment solutions such as photoresist solutions and rust proof solutions. If the organic substances to be removed are photoresist solutions, the surface treatment is an ashing process.

The method for surface treating a substrate may include reforming the substrate surface by producing a hydroxyl group on the substrate surface 70a of an organic substrate.

The flanged plate 17 may be made of a metallic material such as copper, titanium, aluminum, and their respective alloys; an inorganic material such as borosilicate glass and alumina; and an organic material such as acrylic resins and polycarbonate resins.

What is claimed is:

1. A method for surface treating a substrate, comprising:
supplying first plasma generated by using nitrogen gas and oxygen gas toward a substrate surface to surface treat the substrate surface in air, wherein a volume ratio of the oxygen gas to a total supply of the nitrogen gas and the oxygen gas is smaller than a volume ratio of oxygen contained in air.

2. A method for surface treating a substrate, comprising:
supplying oxygen gas and second plasma generated by using nitrogen gas toward a substrate surface to surface treat the substrate surface in air, wherein a volume ratio of the oxygen gas to a total supply of the nitrogen gas and the oxygen gas is smaller than a volume ratio of oxygen contained in air.

3. The method for surface treating a substrate according to claim 1, wherein as a distance between a plasma gun supplying the first plasma and the substrate surface increases the volume ratio of the oxygen gas to the total supply decreases.

4. The method for surface treating a substrate according to claim 1, wherein the volume ratio of the oxygen gas to the total supply is within a range of from 0.01 volume percent to 1 volume percent.

5. A plasma treating apparatus, comprising:
a plasma gun, the gun including: a container having a hollow shape; a pair of electrodes provided to an outer circumferential surface of the container so as to be opposed each other; and a plasma nozzle provided at one end of the container;
a power supply applying a voltage between the pair of electrodes;
a gas supply unit supplying gas to the container for generating plasma; and
a flanged plate circularly bonded to the plasma nozzle.

6. The plasma treating apparatus according to claim 5, wherein the flanged plate has a plasma nozzle side and an outer circumferential side, and is slanted such that the plasma nozzle side is closer to the plasma nozzle than the outer circumferential side in a direction along which the plasma is supplied.
